(19) United States
(12) Patent Application Publication
(10) Pub. No.: US 2012/0057237 A1
(43) Pub. Date: Mar. 8, 2012

(54) ELECTRODE FILM AND COORDINATE DETECTING APPARATUS

(75) Inventors: Hitoshi Wako, Miyagi (JP); Yoshitaka Takahama, Saitama (JP)

(73) Assignee: Sony Corporation, Tokyo (JP)

(21) Appl. No.: 13/223,634

(22) Filed: Sep. 1, 2011

(30) Foreign Application Priority Data
Sep. 8, 2010 (JP) 2010-200776

(51) Int. Cl. G02B 1/10

(52) U.S. Cl. 359/586

(57) ABSTRACT

A laminate includes a high refractive index layer laminated on the base, made of a high refractive index material having an absolute refractive index more than 1.50, and having a thickness of 2 nm or more and 20 nm or less, a low refractive index layer laminated on the high refractive index layer, made of a low refractive index material having an absolute refractive index less than 1.50, and having a thickness of 10 nm or more and 100 nm or less, and a patterned electrode layer laminated on the low refractive index layer, made of a transparent conductive material, and having a surface resistance of 350Ω/□ or less, the laminate having a total luminous transmittance stipulated by JIS K-7105 of 85% or more, and a difference of the total luminous transmittance due to presence/absence of the electrode layer being less than 2%.

### BACKGROUND

The present disclosure relates to an electrode film used in a coordinate detecting apparatus for detecting a pointed position on a display screen, and a coordinate detecting apparatus using the electrode film.

Touchscreens capable of detecting pointed positions on displays employ various detecting principles. Of those, a projected capacitive touchscreen is becoming pervasive for a relatively small display in recent years. A projected capacitive touchscreen is structured such that an electrode film in which an electrode pattern is formed on a base is arranged on a display. When a manipulator such as a finger of a user comes close to the electrode film, the manipulator is electrostatically coupled to the electrode, and a current flowing to an electrode changes. The touchscreen detects the position on a support based on the change of the current.

Here, because an electrode film is arranged on a display, it is desirable not to degrade a visual recognition property of the display by a user. Specifically, an electrode film having a high optical transparency and a small color tone change is desirable. For example, Japanese Patent Application Laid-open No. 2007-299534 (paragraph 0044, FIG. 1) (hereinafter, referred to as Patent Document 1) discloses a “transparent electrode film”. The “transparent electrode film” is structured such that two high refractive index layers made of a high refractive index material and two low refractive index layers made of a low refractive index material are alternately laminated on a transparent film, and a transparent conductive layer is further laminated. It is described that, with this transparent electrode film, reflected lights balance each other out because of the optical path difference of the high refractive index layer and the low refractive index layer, optical transparency is high, and a color tone change is small.

However, in the structure of the above-mentioned transparent electrode film, differences of optical transparency and color tone change due to presence/absence of a transparent conductive layer are not considered. In an electrode film used in a capacitive touchscreen as described above, an electrode layer (transparent conductive layer) is subjected to patterning to detect positions. As a result, the electrode film has areas in which the electrode layer exists and areas in which the electrode layer does not exist. If differences of optical transparency and color tone change between the areas in which the electrode layer exists and the areas in which the electrode layer do not exist are large, a user visually recognizes an electrode pattern, and a visual recognition property of the display is degraded.

### SUMMARY

In view of the above-mentioned circumstances, it is desirable to provide an electrode film and a coordinate detecting apparatus which may prevent degrades of a visual recognition property due to an electrode pattern.

According to an embodiment of the present invention, there is provided an electrode film including a base and a laminate.

The base has optical transparency.

The laminate includes a high refractive index layer laminated on the base, made of a high refractive index material having an absolute refractive index more than 1.50, and having a thickness of 2 nm or more and 20 nm or less, a low refractive index layer laminated on the high refractive index layer, made of a low refractive index material having an absolute refractive index less than 1.50, and having a thickness of 10 nm or more and 100 nm or less, and a patterned electrode layer laminated on the low refractive index layer, made of a transparent conductive material, and having a surface resistance of 350Ω/□ or less, the laminate having a total luminous transmittance stipulated by JIS K-7105 of 85% or more, and a difference of the total luminous transmittance due to presence/absence of the electrode layer being less than 2%.

According to this structure, since the total luminous transmittance is 85% or more, an optical transparency is high. Further, since the difference of the total luminous transmittance due to presence/absence of the electrode layer is less than 2%, visual recognition of the pattern of the electrode layer by a user is prevented.

In the above-mentioned electrode film, a difference of a stimulus value Y of transmittance stipulated by JIS Z-8701 due to presence/absence of the electrode layer may be 2.0 or less.

According to this structure, since the difference of the total luminous transmittance due to presence/absence of the electrode layer is small, visual recognition of the pattern of the electrode layer by a user is prevented.

In the above-mentioned electrode film, a difference of a stimulus value Y of reflectance stipulated by JIS Z-8701 due to presence/absence of the electrode layer may be 2.0 or less.

According to this structure, since the difference of the total luminous reflectance due to presence/absence of the electrode layer is small, visual recognition of the pattern of the electrode layer by a user is prevented.

In the above-mentioned electrode film, a difference of a coordinate in an a*-b* color coordinate space of transmittance stipulated by JIS Z-8729 due to presence/absence of the electrode layer may be 4.0 or less.

According to this structure, since a color difference due to presence/absence of the electrode layer in a transmitted light is small, visual recognition of the pattern of the electrode layer by a user is prevented.

In the above-mentioned electrode film, a difference of a coordinate in an a*-b* color coordinate space of reflectance stipulated by JIS Z-8729 due to presence/absence of the electrode layer may be 4.0 or less.

According to this structure, since a color difference due to presence/absence of the electrode layer in a reflected light is small, visual recognition of the pattern of the electrode layer by a user is prevented.

The high refractive index layer may be made of niobium monoxide, the low refractive index layer may be made of silicon dioxide, and the electrode layer may be made of indium tin oxide.

According to this structure, the total luminous transmittance of the electrode film may be 85% or more, and the difference of the total luminous transmittance due to presence/absence of the electrode layer may be 2% or less.

According to another embodiment of the present invention, there is provided a coordinate detecting apparatus includes a display screen and at least one electrode film.

The display screen is configured to display an image.

The at least one electrode film includes a base having optical transparency, and a laminate including a high refractive index layer laminated on the base, made of a high refractive index material having an absolute refractive index more than 1.50, and having a thickness of 2 nm or more and 20 nm or less, a low refractive index layer laminated on the high refractive index layer, made of a low refractive index material having an absolute refractive index less than 1.50, and having a thickness of 10 nm or more and 100 nm or less, and a patterned electrode layer laminated on the low refractive index layer, made of a transparent conductive material, and having a surface resistance of 350Ω/□ or less, the laminate having a total luminous transmittance stipulated by JIS K-7105 of 85% or more, and a difference of the total luminous transmittance due to presence/absence of the electrode layer being less than 2%.

According to this structure, because visual recognition of the pattern of the electrode layer by a user is prevented, a coordinate detecting apparatus high in visual recognition property of an image displayed on a display screen may be provided.

As described above, according to the embodiments of the present disclosure, an electrode film and a coordinate detecting apparatus which may prevent degrades of a visual recognition property due to an electrode pattern may be provided.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a sectional view showing a laminate structure of an electrode film according to an embodiment of the present disclosure;

FIG. 2 is a perspective view showing an appearance of a patterning of an electrode layer of the electrode film;

FIG. 3 is a table showing measurement results of respective optical properties of laminates including an electrode layer, a high refractive index layer, and a low refractive index layer;

FIG. 4 is a table showing measurement results of respective optical properties of laminates including an electrode layer, a high refractive index layer, and a low refractive index layer;

FIG. 5 is a schematic diagram showing a manufacturing equipment of the electrode film;

FIG. 6 is an exploded perspective view schematically showing a structure of a touchscreen according to the embodiment of the present disclosure;

FIG. 7 are plan views showing arrangements of electrode areas and non-electrode areas of the electrode films according to the embodiment of the present disclosure; and

FIG. 8 is a table showing evaluation results of visual recognition properties of patterns of touchscreens according to application examples of the present disclosure.

### DETAILED DESCRIPTION OF EMBODIMENTS

Hereinafter, an embodiment of the present disclosure will be described with reference to the drawings.

(Structure of Electrode Film)

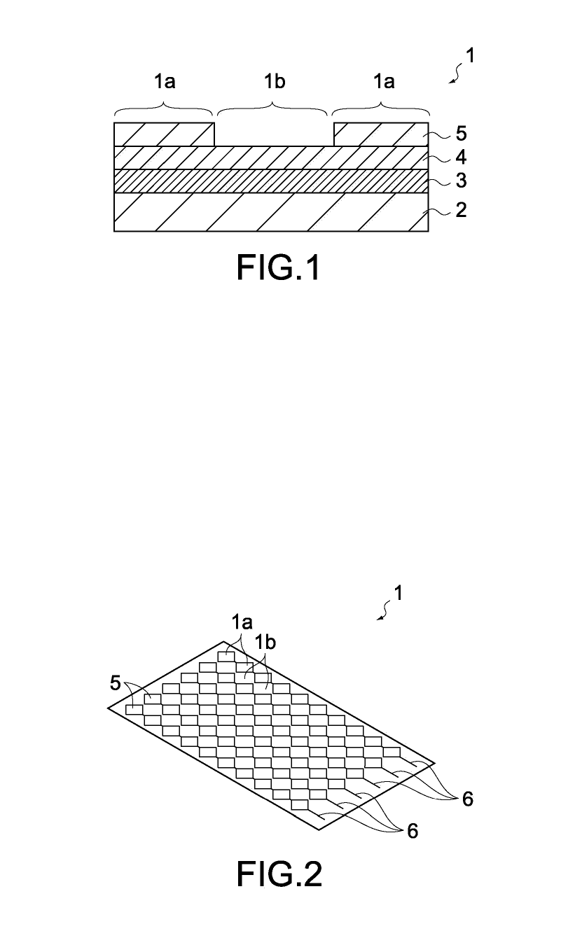

FIG. 1 is a sectional view showing a laminate structure of an electrode film 1 according to an embodiment of the present disclosure.

As shown in FIG. 1, the electrode film 1 includes a base 2, a high refractive index layer 3, a low refractive index layer 4, and an electrode layer 5. They are laminated in this order. The electrode layer 5 has been subjected to patterning. The electrode film 1 includes electrode areas 1a and non-electrode areas 1b. On the electrode areas 1a, the electrode layer 5 is formed. On the non-electrode areas 1b, the electrode layer 5 is not formed.

FIG. 2 is a perspective view showing an appearance of the patterning of the electrode layer 5. As shown in FIG. 2, the electrode layer 5 has been subjected to patterning in rhombuses arrayed in one direction. Wirings 6 are connected to the respective rows. Such a pattern is merely an example. The electrode layer 5 may be subjected to patterning in a pattern different from that. Such a pattern is necessary for detecting a position on a display. Details will be described later.

Hereinafter, structures of the respective layers will be described.

The base 2 shown in FIG. 1 may be made of a flexible material having a high optical transparency, for example, PET (Polyethylene Terephthalate), PEN (Polyethylene naphthalate), stretched COP (Cycloolefin Polymer), or unstretched COP. One obtained by coating each of those materials with an ultraviolet curable resin for the purpose of scratch-proof may be used. Further, the thickness of the base 2 may be, for example, 50 μm or more and 188 μm or less.

The high refractive index layer 3 may be made of a high refractive index material having an absolute refractive index more than 1.50, for example, niobium monoxide (NbO), niobium pentoxide (Nb₂O₅), titanium dioxide (TiO₂), silicon nitride (Si₃N₄), tin dioxide (SnO₂), tantalum pentoxide (Ta₂O₅), zinc oxide (ZnO), silicon monoxide (SiO), or the like. Further, the thickness of the high refractive index layer 3 may be 2 nm or more and 20 nm or less.

The low refractive index layer 4 may be made of a low refractive index material having an absolute refractive index less than 1.50, for example, silicon dioxide (SiO₂), magnesium fluoride (MgF₂), or the like. Further, the thickness of the low refractive index layer 4 may be 10 nm or more and 100 nm or less.

The electrode layer 5 may be made of a transparent conductive material, for example, indium tin oxide (ITO), indium zinc oxide (IZO), aluminum-doped zinc oxide (AZO), or the like. The electrode layer 5 may have a thickness with which a surface resistance is less than 350Ω/□ (in case of ITO, 15 nm>). The surface resistance may be measured compliant with “JIS K-7194” by using “Loresta-GP (registered trademark)” (manufactured by Mitsubishi Chemical Analytech Co., Ltd.).

The electrode film 1 is structured such that the total luminous transmittance of the electrode areas 1a (areas in which the base 2, the high refractive index layer 3, the low refractive index layer 4, and the electrode layer 5 are laminated) is 85% or more. Further, the electrode film 1 is structured such that the difference between the total luminous transmittance of the electrode areas 1a and the total luminous transmittance of the non-electrode areas 1b (areas in which the base 2, the high refractive index layer 3, and the low refractive index layer 4 are laminated) is less than 2%. Note that the total luminous transmittance may be measured compliant with “JIS K-7105” by using “NDH 5000” (manufactured by Nippon Denshoku Industries Co., Ltd.).

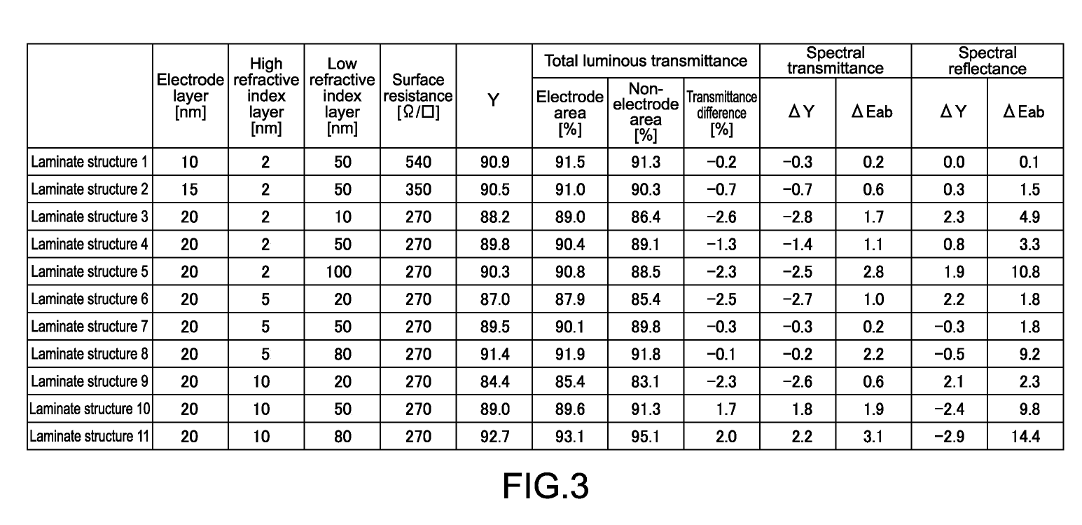

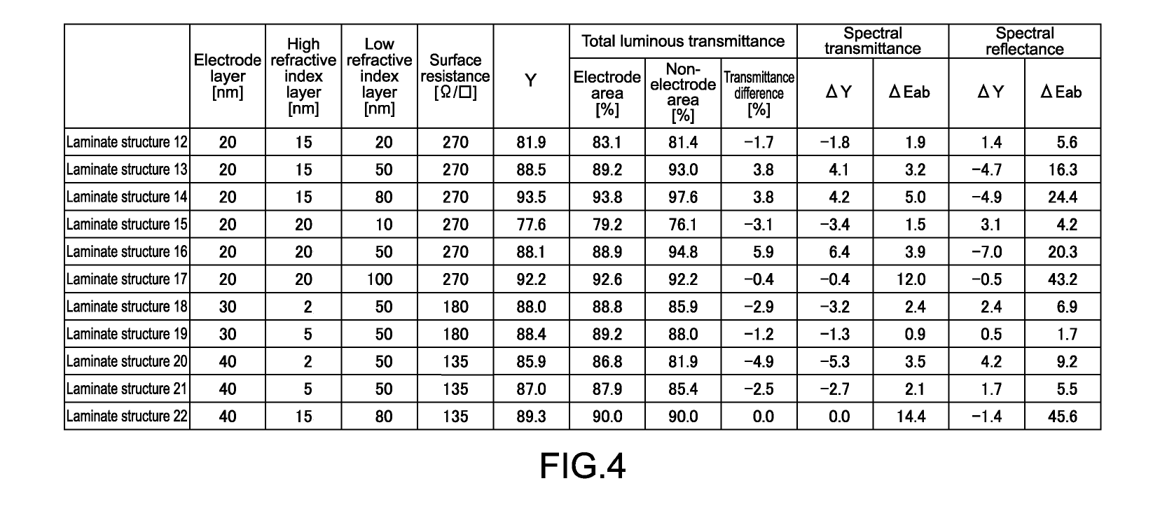

FIGS. 3 and 4 are tables showing measurement results of the respective optical properties of laminates including an electrode layer, a high refractive index layer, and a low refractive index layer. A laminate in which an electrode layer, a high refractive index layer, and a low refractive index layer are laminated is referred to as “laminate structure”. In each of the laminate structures, the electrode layer is made of ITO, the high refractive index layer is made of niobium pentoxide, and the low refractive index layer is made of silicon dioxide. FIGS. 3 and 4 show the respective values of the thicknesses of the respective layers, “surface resistance”, “stimulus value Y”, “total luminous transmittance”, “spectral transmittance”, and “spectral reflectance” of the respective laminate structures.

A surface resistance has a dependence on the thickness of an electrode layer. Because the thicknesses of the electrode layers of the laminate structure 1 and the laminate structure 2 are small, the surface resistances are 350Ω/□ or more. As a result, the laminate structure 1 and the laminate structure 2 are not suitable for an electrode film for a touchscreen.

The total luminous transmittance is a value measured by a measurement method stipulated by “JIS K-7105”. The total luminous transmittance has a dependence on the thicknesses of an electrode layer, a high refractive index layer, and a low refractive index layer, and the absolute refractive index. FIGS. 3 and 4 show the total luminous transmittance of electrode areas, total luminous transmittance of non-electrode areas, and the difference therebetween of each of the laminate structures. As shown in FIGS. 3 and 4, the total luminous transmittances of the electrode areas and the non-electrode areas do not increase/decrease in response to the thicknesses of an electrode layer, a high refractive index layer, and a low refractive index layer. Even if the thicknesses of the respective layers are large, they may decrease. The reason is as follows. A light entering a laminate is reflected by interfaces of the respective layers. The phases of the reflected lights are different from each other because of the difference of the absolute refractive indexes of the respective layers. If the thicknesses of the respective layers are appropriate, the reflected lights balance each other out, and the transmittance increases. As shown in FIGS. 3 and 4, the total luminous transmittance of a laminate structure in which the thicknesses of the respective layers are appropriate is 85% or more. The laminate structures except for the laminate structures 12 and 15 achieve total luminous transmittances of 85% or more. The transmittance difference is the difference of the total luminous transmittances of an electrode area and a non-electrode area. Note that a positive value indicates that a total luminous transmittance decreases in the presence of the electrode layer. A negative value indicates that a total luminous transmittance increases in the presence of the electrode layer. As shown in FIGS. 3 and 4, the laminate structures 4, 7, 8, 10, 17, 19, and 22 achieve transmittance differences less than 2%.

In view of those measurement results, the laminate structures 4, 7, 8, 10, 17, 19, and 22 achieve surface resistances of the electrode layers less than 350Ω/□, total luminous transmittances of 85% or more, and transmittance differences less than 2%. That is, in a case where thicknesses of the respective layers have values of those laminate structures, the electrode film 1 achieves a high optical transparency. Further, the difference between the optical transparency of the electrode areas 1a and the optical transparency the non-electrode areas 1b is decreased. Therefore, a user may easily visually recognize the interface between the electrode areas 1a and the non-electrode areas 1b, that is, an electrode pattern.

Further, in addition to the above-mentioned structure, the electrode film 1 is structured such that a difference “ΔY” of “stimulus values Y” due to presence/absence of an electrode layer is 2.0 or less. A stimulus value may be calculated based on measured values of a transmittance and a reflectance in a wavelength range of 380 nm to 780 nm measured at an incident angle of 12° by using a spectroscopic measuring device and a calculation method stipulated by “JIS Z-8701”. Specifically, a transmittance and a reflectance to a light from an illuminant D65 may be measured by using “U-4100” (manufactured by Hitachi High-Technologies Corporation (registered trademark)). As stimulus values, there are a stimulus value Z to blue (z), a stimulus value Y to green (y), and a stimulus value X to red (x). Here, a stimulus value Y to green (y) is used. As shown in FIGS. 3 and 4, of the laminate structures 4, 7, 8, 10, 17, 19, and 22, the laminate structures 4, 7, and 19 have ΔYs of a spectral transmittance of 2.0% or less and ΔYs of a spectral reflectance of 2.0% or less.

The electrode film 1 having each of those laminate structures has a small difference between the optical reflectance of the electrode areas 1a and the optical reflectance of the non-electrode areas 1b. As a result, recognition of an electrode pattern by a user due to a difference between the optical reflectance of the electrode area 1a and the optical reflectance of the non-electrode area 1b is prevented.

Further, in addition to the above-mentioned structure, the electrode film 1 is structured such that a change amount ΔEab in an a*-b* color coordinate space due to presence/absence of an electrode layer is 4.0 or less. The a*-b* color coordinate space is a kind of a color space, and mimics nonlinear responses of the human eye. Therefore, a Euclidean distance between two coordinates in the a*-b* color coordinate space may be regarded as a relative perceptual difference of the human eye. The change amount in the a*-b* color coordinate space may be calculated based on measured values of a transmittance and a reflectance in a wavelength range of 380 nm to 780 nm measured at an incident angle of 12° by using a spectroscopic measuring device by using a calculation method stipulated by “JIS Z-8729”. As shown in FIGS. 3 and 4, each of the laminate structures 4, 7, and 19 has ΔY of a spectral transmittance of 2.0% or less and ΔY of a spectral reflectance of 2.0% or less. Further, each of the laminate structures 4, 7, and 19 has ΔEab of a spectral transmittance of 4.0 or less and ΔEab of a spectral reflectance of 4.0 or less.

The electrode film 1 having those laminate structures is small to such an extent that a difference between the color of the electrode area 1a and the color of the non-electrode area 1b is unnoticeable with the human eye. As a result, recognition of an electrode pattern by a user due to a difference between the color of the electrode area 1a and the color of the non-electrode area 1b is prevented.

As described above, the electrode film 1 of this embodiment is structured such that the total luminous transmittance of the electrode areas 1a is 85% or more, and the difference between the total luminous transmittance of the electrode areas 1a and the total luminous transmittance of the non-electrode areas 1b is less than 2%. As a result, recognition of an electrode pattern by a user due to the difference between the optical transmittance of the electrode areas 1a and the optical transmittance of the non-electrode areas 1b is prevented. Further, the electrode film of this embodiment is structured such that the difference between the stimulus value Y of the electrode area 1a and the stimulus value Y of the non-electrode area 1b is 2.0 or less. As a result, recognition of an electrode pattern by a user due to the difference between the optical reflectance of the electrode areas 1a and the optical reflectance of the non-electrode areas 1b is prevented. Further, the electrode film of this embodiment is structured such that the change amount in the a*-b* color coordinate space of the electrode areas 1a and the non-electrode areas 1b is 4.0 or less. As a result, recognition of an electrode pattern by a user due to the difference of the color of the electrode areas 1a and the color of the non-electrode areas 1b is prevented. That is, in the electrode film 1, the difference between the optical property of the electrode areas 1a and the optical property of the non-electrode areas 1b is small. Therefore, with the electrode film 1, visual recognition of the pattern by a user is prevented, and a visual recognition property of the display may not be degraded.

(Manufacturing Method of Electrode Film)

A manufacturing method of the electrode film 1 will be described.

Here, as an example, it is assumed that, in the electrode film 1, the high refractive index layer 3 is niobium pentoxide (Nb₂O₅), the low refractive index layer 4 is silicon dioxide (SiO₂), and the electrode layer 5 is indium tin oxide (ITO), and description will be made.

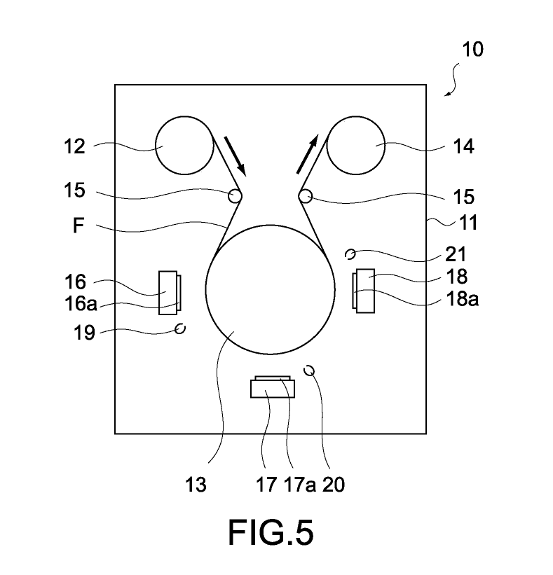

FIG. 5 is a schematic diagram showing a manufacturing equipment 10 of the electrode film 1.

As shown in FIG. 5, the manufacturing equipment 10 includes a chamber 11, a wind-off spool 12, a main roll 13, a wind-up spool 14, guide rolls 15, a first cathode 16, a second cathode 17, and the third cathode 18. The wind-off spool 12, the main roll 13, the wind-up spool 14, the guide rolls 15, the first cathode 16, the second cathode 17, and the third cathode 18 are stored in the chamber 11.

A film F as a material of the base 2 is set on the wind-off spool 12, the main roll 13, and the guide rolls 15. The film F may be a film obtained by coating a PET resin film with an acrylic resin. The film F wound off the wind-off spool 12 is wound around the main roll 13 and the wind-up spool 14 via the guide rolls 15. By rotating the wind-off spool 12 and the wind-up spool 14, the film F may travel from the wind-off spool 12 to the wind-up spool 14 via the main roll 13.

Each of the first cathode 16, the second cathode 17, and the third cathode 18 is a sputtering cathode on which a predetermined sputtering target is provided. Each of the first cathode 16, the second cathode 17, and the third cathode 18 is arranged in a manner that they face the main roll 13. They are arranged in the order of the first cathode 16, the second cathode 17, and the third cathode 18 from the wind-off spool 12 side, that is, the upstream side of the film F. Further, a first gas injecting pipe 19 is provided in the vicinity of the first cathode 16. A second gas injecting pipe 20 is provided in the vicinity of the second cathode 17. A third gas injecting pipe 21 is provided in the vicinity of the third cathode 18.

The first cathode 16 is a cathode for forming the high refractive index layer 3, and includes a target material 16a made of Nb. The second cathode 17 is a cathode for forming the low refractive index layer 4, and includes a target material 17a made of Si. The third cathode 18 is a cathode for forming the electrode layer 5, and includes a target material 18a made of In—Sn—O composite oxide. Ar and O₂ are supplied to the chamber 11 as plasma producing gas, and sputters (reactive sputters) are generated by using those targets. Therefore, films made of Nb₂O₅, SiO₂, and ITO are formed, respectively. The above-mentioned target materials and plasma producing gas may be arbitrarily changed in response to materials of the respective layers.

The manufacturing processes of the electrode film 1 will be described.

After the film F is set as described above, the chamber 11 is evacuated. In this case, the film F may be reciprocated to remove gas included in the film F. After the chamber 11 is decompressed to about 1×10⁻³ Pa, the plasma producing gas (for example, Ar) is introduced from the first gas injecting pipe 19, the second gas injecting pipe 20, and the third gas injecting pipe 21. In this case, the flow rate of the plasma producing gas is adjusted such that the pressure in the chamber 11 is about 0.5 Pa.

Next, power is applied to the first cathode 16, the second cathode 17, and the third cathode 18, and the plasma producing gas is changed to plasma. The applied voltages to the respective cathodes are gradually increased and adjusted to achieve predetermined powers. In this case, deformation of the film F due to a thermal load due to plasma discharge may be prevented by causing the film F to travel at an extremely low speed. The powers applied to the respective cathodes are determined based on relations between a preliminary obtained film-formation speed and powers.

Subsequently, an extremely small amount of O₂ gas is injected from each of the gas injecting pipes, and the film F is started to travel.

The wind-off spool 12 and the wind-up spool 14 rotate, whereby the film F travels on the main roll 13. Sputter particles generated from the target materials of the respective cathodes by the plasma fly to the film F. The first cathode 16 provided on the upstream side of the traveling film F laminates the film F (base 2) with the high refractive index layer 3 made of Nb₂O₅. The second cathode 17 provided next laminates the high refractive index layer 3 with the low refractive index layer 4 made of SiO₂. Further, the third cathode 18 laminates the low refractive index layer 4 with the electrode layer 5 made of ITO. The wind-up spool 14 winds up the formed laminate, and the film formation is completed.

Subsequently, the electrode layer 5 of the above-mentioned laminate is subjected to patterning by an etching method or the like, and the laminate is cut at a predetermined size. As a result, the electrode film 1 is manufactured. Note that the electrode film 1 may be manufactured by using a method different from the method described above. For example, a plurality of sputtering cathodes may be provided for one material. Alternatively, only one sputtering cathode may be provided, and, after a film made of a single material is formed, a sputtering target is changed and a film may be formed again. Other than the sputtering method, a deposition method, a plasma CVD (Chemical Vapor Deposition) method, a laser ablation method, or the like may be employed to form the respective layers. In the above-described manner, the electrode film 1 may be manufactured. Note that the electrode film 1 manufactured as described above is subjected to heat treatment at 150° C. for 60 minutes by using an oven to prevent size deformation and to crystallize the electrode layer 5. Measurement of the above-mentioned optical property is performed to the above-mentioned heat-treated film.

(Structure of Touchscreen)

Next, a touchscreen using the electrode film 1 will be described.

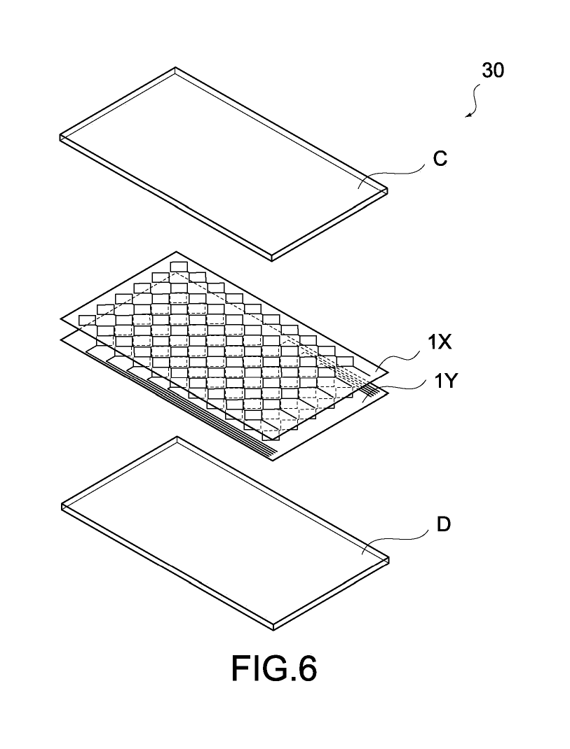

FIG. 6 is an exploded perspective view schematically showing the structure of a touchscreen 30.

As shown in FIG. 6, the touchscreen 30 includes a display D, two electrode films 1 (hereinafter, electrode film 1X and electrode film 1Y), and a cover panel C, which are laminated. The display D is an LCD (Liquid Crystal Display) or the like. The cover panel C protects the electrode film 1. The cover panel C and the display D sandwich the electrode film 1X and the electrode film 1Y. The electrode film 1X and the electrode film 1Y are bonded together with a transparent adhesive or glue. Note that, in FIG. 6, illustration of a casing of an electronic apparatus including the touchscreen 30, a drive circuit for the touchscreen 30, and the like is omitted.

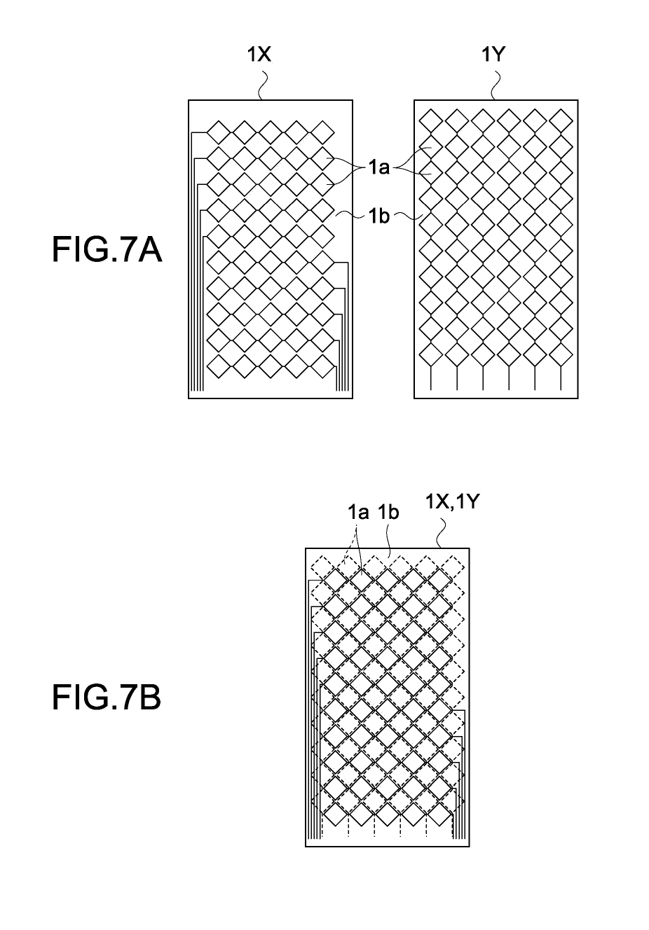

The arrangement of the electrode areas 1a and the non-electrode areas 1b of the electrode film 1X is different from the arrangement of the electrode areas 1a and the non-electrode areas 1b of the electrode film 1Y. FIGS. 7A and 7B are plan views showing the arrangement of the electrode areas 1a and the non-electrode areas 1b of the electrode film 1X and the arrangement of the electrode areas 1a and the non-electrode areas 1b of the electrode film 1Y. FIG. 7A shows the arrangement of the electrode areas 1a and the non-electrode areas 1b of the electrode film 1X and the arrangement of the electrode areas 1a and the non-electrode areas 1b of the electrode film 1Y. FIG. 7B shows the arrangement of the electrode areas 1a and the non-electrode areas 1b of the respective electrode film 1X and electrode film 1Y in a state where the electrode film 1X and the electrode film 1Y are superimposed on one another. As shown in FIGS. 7A and 7B, the direction in which the rhombic electrode patterns are connected on the electrode film 1X is different from the direction in which the rhombic electrode patterns are connected on the electrode film 1Y. Those directions are orthogonal to each other. Further, the electrode film 1X and the electrode film 1Y are arranged such that the electrode areas 1a of the electrode film 1X do not overlap the electrode areas 1a of the electrode film 1Y when they are laminated.

Here, the operation principle of the touchscreen 30 uses the following phenomenon. That is, when a manipulator comes close to the electrode film 1X and the electrode film 1Y via the cover panel C, because of capacitive coupling between the manipulator and the electrode areas 1a in the respective electrode films, an electrode wire intersection capacity decreases. Based on an output of a detector circuit connected to the electrode areas 1a, an intersection position in which an intersection capacity decreases, that is, an intersection position to which a finger of a user comes close is specified. Therefore, a pointed position coordinate is detected. Because of this, the electrode areas 1a of the electrode film 1X and the electrode areas 1a of the electrode film 1Y are formed such that they are not overlapped with each other and that areas allowing capacitive coupling with a manipulator are large.

As shown in FIG. 7B, the electrode areas 1a of one of the electrode film 1X and the electrode film 1Y do not completely coincide with the non-electrode areas 1b of the other electrode film. Gaps are formed between the electrode areas 1a of the two electrode films. The reason is as follows. If the electrode areas 1a are overlapped with each other, an optical transparency in the overlapped portion decreases. Therefore, in a state where the electrode film 1X and the electrode film 1Y are superimposed on one another, areas in which the electrode areas 1a and the non-electrode areas 1b of the respective electrode films are overlapped with each other (hereinafter, patterned areas) and areas in which the non-electrode areas 1b of the respective electrode films are overlapped with each other (hereinafter, unpatterned areas) exist.

Therefore, if the optical property of the electrode areas 1a is different from the optical property of the non-electrode areas 1b in the electrode film 1, the optical property of the above-mentioned patterned areas is different from the optical property of the above-mentioned unpatterned areas. Here, in the touchscreen of this embodiment, as described above, the difference between the optical property of the electrode areas 1a and the optical property of the non-electrode areas 1b of the respective electrode films 1 is small. Therefore, the difference between the optical property of the patterned areas and the optical property of the unpatterned areas is also small. Further, a visual recognition property of the display may not be degraded.

### Application Examples

Hereinafter, application examples of this embodiment will be described.

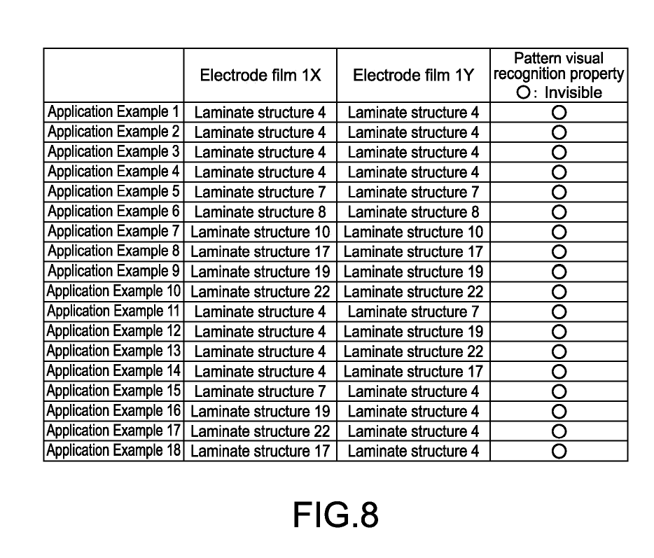

In the application examples, the electrode films 1X and the electrode films 1Y having various structures are superimposed on one another. Visual recognition properties with eyes are evaluated. FIG. 8 is a table showing evaluation results of visual recognition properties of patterns of touchscreens of the application examples. The employed laminate structures are the respective laminate structures of the above-mentioned embodiment.

As shown in FIG. 8, in a case where the employed laminate structures are the laminate structures 4, 7, 8, 10, 17, 19, and 22 shown in the above-mentioned embodiment, that is, in a case where the total luminous transmittance is 85% or more and the transmittance difference between the electrode areas and the non-electrode areas is less than 2%, visual recognition properties of the patterns of the touchscreens are satisfactory.

The present disclosure is not limited to this embodiment, and may be modified within the gist of the present disclosure.

In this embodiment, it is assumed that the coordinate detecting apparatus is a projected capacitive touchscreen, but it is not limited to this. The present disclosure may be applied to, for example, a matrix resistive touchscreen in which an electrode pattern is formed.

The present disclosure contains subject matter related to that disclosed in Japanese Priority Patent Application JP 2010-200776 filed in the Japan Patent Office on Sep. 8, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electrode film, comprising:
a base having optical transparency; and
a laminate including
a high refractive index layer laminated on the base, made of a high refractive index material having an absolute refractive index more than 1.50, and having a thickness of 2 nm or more and 20 nm or less,
a low refractive index layer laminated on the high refractive index layer, made of a low refractive index material having an absolute refractive index less than 1.50, and having a thickness of 10 nm or more and 100 nm or less, and
a patterned electrode layer laminated on the low refractive index layer, made of a transparent conductive material, and having a surface resistance of 350Ω/□ or less,
the laminate having a total luminous transmittance stipulated by JIS K-7105 of 85% or more, and a difference of the total luminous transmittance due to presence/absence of the electrode layer being less than 2%.

2. The electrode film according to claim 1, wherein
a difference of a stimulus value Y of transmittance stipulated by JIS Z-8701 due to presence/absence of the electrode layer is 2.0 or less.

3. The electrode film according to claim 1, wherein
a difference of a stimulus value Y of reflectance stipulated by JIS Z-8701 due to presence/absence of the electrode layer is 2.0 or less.

4. The electrode film according to claim 1, wherein
a difference of a coordinate in an a*-b* color coordinate space of transmittance stipulated by JIS Z-8729 due to presence/absence of the electrode layer is 4.0 or less.

5. The electrode film according to claim 1,
a difference of a coordinate in an a*-b* color coordinate space of reflectance stipulated by JIS Z-8729 due to presence/absence of the electrode layer is 4.0 or less.

6. The electrode film according to claim 1, wherein
the high refractive index layer is made of niobium monoxide,
the low refractive index layer is made of silicon dioxide, and
the electrode layer is made of indium tin oxide.

7. A coordinate detecting apparatus, comprising:
a display screen configured to display an image; and
at least one electrode film including
a base having optical transparency, and
a laminate including
a high refractive index layer laminated on the base, made of a high refractive index material having an absolute refractive index more than 1.50, and having a thickness of 2 nm or more and 20 nm or less,
a low refractive index layer laminated on the high refractive index layer, made of a low refractive index material having an absolute refractive index less than 1.50, and having a thickness of 10 nm or more and 100 nm or less, and
a patterned electrode layer laminated on the low refractive index layer, made of a transparent conductive material, and having a surface resistance of 350Ω/□ or less,
the laminate having a total luminous transmittance stipulated by JIS K-7105 of 85% or more, and a difference of the total luminous transmittance due to presence/absence of the electrode layer being less than 2%.
